(19) United States
(12) Patent Application Publication
(10) Pub. No.: US 2009/0137441 A1
(43) Pub. Date: May 28, 2009

(54) Fast Release Granules

(76) Inventors: Andrew Paul Chapple, Wirral (GB); Stephen Thomas Keningley, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/225,015

(22) PCT Filed: Feb. 16, 2007
(86) PCT No.: PCT/EP2007/001557

§ 371 Date: Sep. 11, 2008

(30) Foreign Application Priority Data
Mar. 14, 2006 (EP) 06251352.8

(51) Int. Cl. C11D 1/66; C11D 11/00; C11D 3/20

(52) U.S. Cl. 510/276

(57) ABSTRACT

The present invention provides a granule that releases antioxidants rapidly and a method of preparing an antioxidant granule comprising the steps of: (i) melting a non-ionic surfactant the nonionic surfactant having a starting melting point of 40° C. or above as measured by differential scanning calorimetry; (ii) dissolving an antioxidant in the melted non-ionic surfactant with mixing to form a antioxidant/non-ionic solution; (iii) cooling the antioxidant/non-ionic solution to form a solid whilst forming a particulate matter.

### FIELD OF INVENTION

The present invention relates to granule conferring improved delivery of antioxidants to wash liquor.

### BACKGROUND OF INVENTION

Rapid delivery of adjuncts to a wash medium is important because it is necessary to have active adjuncts present in the wash liquor for the maximum time so that they perform in the most efficacious manner.

GB 1344253 discloses a non-ionic surfactant matrix comprising enzymes.

### SUMMARY OF INVENTION

The present invention provides a granule that releases an antioxidant rapidly into a wash medium.

In one aspect the present invention provides a granule comprising:
(i) nonionic surfactant, the nonionic surfactant having a starting melting point of 40° C. or above as measured by differential scanning calorimetry; and,
(ii) and an antioxidant, wherein the antioxidant is dissolved in the non-ionic surfactant.

Preferably the weight ratio of antioxidant to non-ionic is in the range from 1:100 to 20:100, preferably 3:100 to 17:100, most preferably 5:100 to 15:100.

The granules are preferably a sieve fraction in the range 180 to 1400 microns.

It is preferred that a laundry detergent powder containing the granules is such that the antioxidant granule is present in the range 0.1 to 5.0 wt %.

In another aspect the present invention provides a method of preparing an antioxidant granule comprising the steps of:
(i) melting a non-ionic surfactant the nonionic surfactant having a starting melting point of 40° C. or above as measured by differential scanning calorimetry;
(ii) dissolving an antioxidant in the melted non-ionic surfactant with mixing to form a antioxidant/non-ionic solution;
(iii) cooling the antioxidant/non-ionic solution to form a solid whilst forming a particulate matter.

In a further aspect of the present invention there is provided a method of treating a textile with the antioxidant granules of the present invention in an aqueous medium, followed by rinsing and drying the textile.

### DETAILED DESCRIPTION OF THE INVENTION

### The Granule

The granule is preferably a sieve fraction in the range 180 to 1400 microns. The granule is preferably used in a laundry detergent powder formulation in the range from 0.1 to 5 wt %.

### Antioxidant

Anti-oxidants are substances as described in Kirk-Othmers (Vol 3, pg 424) and in Uhlmans Encyclopedia (Vol 3, pg 91) and CRC Press Oxidation Inhibition in Organic Materials Vols. I and II, Eds. Jan Pospisil and Peter P. Klemchuk: ISBN 0-8493-4767-X and 0-8493-4768-8.

One class of anti-oxidants suitable for use in the present invention is alkylated phenols having the general formula:

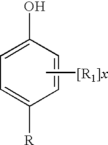

wherein R is C1-C22 linear or branched alkyl, preferably methyl or branched C3-C6 alkyl; C3-C6 alkoxy, preferably methoxy; R1 is a C3-C6 branched alkyl, preferably tert-butyl; x is 1 or 2. Hindered phenolic compounds are preferred as antioxidant.

Another class of anti-oxidants suitable for use in the present invention is a benzofuran or benzopyran derivative having the formula:

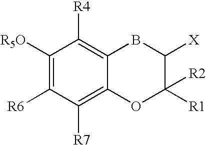

wherein R1 and R2 are each independently alkyl or R1 and R2 can be taken together to form a C5-C6 cyclic hydrocarbyl moiety; B is absent or CH2; R4 is C1-C6 alkyl; R5 is hydrogen or —C(O)R3 wherein R3 is hydrogen or C1-C19 alkyl; R6 is C1-C6 alkyl; R7 is hydrogen or C1-C6 alkyl; X is —CH2OH, or —CH2A wherein A is a nitrogen comprising unit, phenyl, or substituted phenyl. Preferred nitrogen comprising A units include amino, pyrrolidino, piperidino, morpholino, piperazino, and mixtures thereof.

Other suitable antioxidants are found as follows. A derivative of α-tocopherol, beta-tocopherol, gamma-tocopherol, delta-tocopherol, and alkyl esters of gallic acid, especially octyl gallate and dodecyl gallate.

Another example of suitable antioxidants are the class of hindered amine light stabilisers (HALS), particularly those based 2,2,6,6-tetramethylpipiridines.

Preferred anti-oxidants are phenols, in particular 2,6-di-tert-butylphenol, 2,6-di-tert-butyl-4-methylphenol, and mixtures of 2 and 3-tert-butyl-4-methoxyphenol. A preferred antioxidant is 4,4′-isopropylidenebis(2,6-dimethylphenol).

Mixtures of antioxidants may be use and in particular mixtures that have synergic antioxidant.

### Non-Ionic Surfactant

The non-ionic surfactant may be, for example, fatty alcohol polyethylene glycol ether or fatty alcohol ethoxylates, alkylphenol ethoxylates, ethylene oxide and propylene oxide co-polymers, amine oxides, alkylamines, alkanolamines, polyglycerol esters, alkyl polyglucosides, and fatty acid N-alkylglucosamides. Preferred non-ionics are fatty alcohol polyethylene glycol ether or fatty alcohol ethoxylates. A preferred class of non-ionic surfactant is an alkyl chain in the range C10 to C18 linked to repeated ethoxylate groups; most preferred are alkyl chains having a chain length range C12 to C15. One will appreciate that the melting point of the non-ionic is effected by both the chain length or nature of the chain length i.e., branching and number of ethoxylate/propyloxlate groups.

The greater the number of repeated ethoxylate groups the greater the melting point of the non-ionic surfactant. A preferred non-ionic surfactant is a C10 to C18 alkyl chain distribution covalently bound to at least 40 EO; the link between the ethoxylate and the alkyl chain may either be an ester (fatty alcohol ethoxylates) or an ether linkage (fatty alcohol polyethylene glycol ether).

The non-ionic surfactant has a melting point range that starts at 40° C. or above as measured by Differential Scanning Calorimetry (DSC). The DCS determines the start of the melting point by monitoring deviation from linearity of the energy input during the heating process. Preferably the non-ionic surfactant has melting range that does not exceed 100° C., more preferably 150° C., most preferably 200° C. The DSC protocol is given in the experimental section.

Non-ionic Lutensol™ named surfactants obtained from BASF and Non-ionic Genapol™ named surfactants obtained from Clariant having the requisite melting point were particularly suitable.

### Other Aspects

Other adjuncts or carriers may be present in the granule. Preferred carriers are water soluble, e.g., sodium sulphate. Examples of adjuncts are perfumes, dyes, brightening agents, enzymes etc. These may be incorporated by cogranulation. Adjuncts may be added to the non-ionic before or during granulation. The non-ionic may itself act as a binder which negates the need for further binder material.

The granule may itself be coated with, for example, sodium alginate, calcium cross linked alginate, wax and the like.

The granule may be also dusted with a fine powder to aid flow—for example zeolite, silica, clay, sodium sulphate.

### EXPERIMENTAL

### Anti-Oxidant/Solid Nonionic Granules

1) 2,6-di-tert-butyl-4 methylphenol/50EONI

### Materials

90 gms of Genapol T 500 (Tallow 50EO nonionic) was heated to approximately 60 C and 10 gms of 2,6-di-tert-butyl-4 methylphenol dissolved in the melt with mixing until a clear solution obtained. The melt was poured and cooled rapidly to form a thin film of approximately 0.5 to 1 mm thickness on a plastic tray at 25 C. The resulting solid film was milled to the correct size fraction using a Moulinette mixer. The milled product was sieved to provide a powder sized between 180 and 1000 microns.

2) The same process an for 1) was applied to antioxidant 4,4′-isopropylidenebis(2,6-dimethylphenol) with the same weights.
3) Granule, prepared by high shear mixer granulation, containing 11.6% 2,6-di-tert-butyl-4 methylphenol, 54.3% zeolite, 11.6% ascorbic acid and 22.5% PEG6000, where the 2,6-di-tert-butyl-4 methylphenol was added as a milled powder.
4) Granule, prepared by high shear mixer granulation, containing 12.7% 2,6-di-tert-butyl-4 methylphenol, 59.2% sodium sulphate, 12.7% ascorbic acid and 15.4% PEG6000, where the 2,6-di-tert-butyl-4 methylphenol was added as a milled powder.
5) Granule, prepared by high shear mixer granulation, containing 12.0% 2,6-di-tert-butyl-4 methylphenol, 57.3% zeolite, 12.0 ascorbic acid and 18.7% Genapol T-500 (Clariant), where the 2,6-di-tert-butyl-4 methylphenol was added as a melt.
6) Granule, prepared by high shear mixer granulation, containing 12.6% 4,4′-isopropylidenebis(2,6-dimethylphenol), 84.9% sodium sulphate and 2.6% Sokalan CP13S (BASF), where the 4,4′-isopropylidenebis(2,6-dimethylphenol) was added as a milled powder.

### Rate of Release Method

4 g of detergent powder (in this instance OMO MA) was dissolved in 1 litre of demin. water at room temperature and stirred (magnetic stirrer) for 20 minutes in order for complete dissolution.

After the dissolution period, 0.1 g of the antioxidant containing granules, sieve fraction 180 to 1000 microns, were added to the solution with constant stirring.

A small sample of the solution was taken after 5 minutes using a 2 ml syringe. This sample was immediately filtered through a Whatman Puradisc (1.0 micromol polyethersulfone membrane) filter. The filtered sample was analysed by HPLC to determine the percentage of antioxidant released.

The amount of anti-oxidant released into the wash solution after 5 minutes, for each of the examples, is shown in the following table.

| Example | % Anti-oxidant Released after 5 minutes |
|---|---|
| 1 | 100 |
| 2 | 64 |
| Comparative 3 | 12 |
| Comparative 4 | 12 |
| Comparative 5 | 36 |
| Comparative 6 | 28 |

### Melting Point of the Non-Ionic Surfactants

Melting point ranges of some commercial surfactants were identified by heat cool cycling of a sample in the Perkin Elmer™ DSC7 differential scanning calorimeter. Samples were cooled to 0° C. then heated to 110° C. and cooled to 0° C. at a rate of 10° C. per minute. This was repeated to confirm the melting range.

The following table melting point ranges for some non-ionics are illustrated.

| Non-ionic Surfactant | DSC melting range/° C. |
|---|---|
| Lutensol AT25 | 40 to 60 |
| Lutensol AT50 | 47 to 65 |
| Lutensol AT80 | 50 to 63 |
| Lutensol AO30 | 30 to 58 |
| Lutensol TO20 | — to 32 |
| Genapol T500 (50EO) | 48 to 65 |
| Genapol T800 (80EO) | 50 to 68 |

The table shows that the AT series of surfactants have higher melting points than the AO series. This is due to the AT series being prepared from a C16/C18 alcohol while the AO series are prepared from C13/C15 alcohol. The TO sample uses a branched alcohol.

1. A granule comprising:
(i) nonionic surfactant, the nonionic surfactant having a starting melting point of 40° C. or above as measured by differential scanning calorimetry; and,
(ii) and an antioxidant, wherein the antioxidant is dissolved in the non-ionic surfactant.

2. A granule according to claim 1, wherein the weight ratio of antioxidant to non-ionic is in the range from 1:100 to 20:100.

3. A granule according to claim 2, wherein the weight ratio of antioxidant to non-ionic is in the range from 3:100 to 17:100.

4. A granule according to claim 3, wherein the weight ratio of antioxidant to non-ionic is in the range from 5:100 to 15:100.

5. A granule according to claim 1, wherein the antioxidant is selected from the group consisting of: 2,6-di-tert-butylphenol, 2,6-di-tert-butyl-4-methylphenol, and 4,4′-isopropylidenebis(2,6-dimethylphenol).

6. A granule according to claim 1, wherein the non-ionic is selected from is a C10 to C18 alkyl chain covalently bound to at least 40 EO.

7. A granule according to claim 1, wherein the antioxidant granules are a sieve fraction in the range 180 to 1400 microns.

8. A laundry detergent powder formulation comprising the antioxidant granule, as defined in claim 1, in the range 0.1 to 5.0 wt %.

9. A method of preparing an antioxidant granule comprising the steps of:
(i) melting a non-ionic surfactant the nonionic surfactant having a starting melting point of 40° C. or above as measured by differential scanning calorimetry;
(ii) dissolving an antioxidant in the melted non-ionic surfactant with mixing to form a antioxidant/non-ionic solution;
(iii) cooling the antioxidant/non-ionic solution to form a solid whilst forming a particulate matter.
